(19) United States
(12) Patent Application Publication
(10) Pub. No.: US 2004/0189462 A1
(43) Pub. Date: Sep. 30, 2004

(54) Signalling device for the operating state of an appliance

(76) Inventors: Frank Eilers, Bad Driburg (DE); Petra Eilers, Bad Driburg (DE)

Correspondence Address: BROWDY AND NEIMARK, P.L.L.C., 624 NINTH STREET, NW, SUITE 300, WASHINGTON, DC, 20001-5303, US

(21) Appl. No.: 10/486,222

(22) PCT Filed: Jul. 27, 2002
(86) PCT No.: PCT/EP02/08403

(30) Foreign Application Priority Data
Aug. 2, 2001 (EP) 01119010.5
Aug. 14, 2001 (DE) 10140104.3
Oct. 7, 2001 (DE) 10149440.8

(51) Int. Cl. G08B 1/00

(52) U.S. Cl. 340/531

(57) ABSTRACT

The invention relates to a signalling device (12, 2; 42, 2A) for detecting an operating state (B) of a machine (1) or an appliance, and for transmitting an operating state signal (SS, B, B*) associated therewith to a receiver circuit (2, 42) which is a spatially separated part of the signalling device (12, 2; 42, 2A) and converts said signal (SS, B, B*) into an optical, acoustic and/or tactile signal and outputs the same. The operating state signal (SS) passes through an amplitude threshold value circuit (V) and part of the signal (B) exceeding the threshold value is supplied to a retriggerable time overtravel circuit (NS), during the time interval of which the final operating state signal (BE) is used to form the alarm signal.

Signaling Device for the Operating Status of an Appliance

The present invention relates to a signaling device for detecting the operating status of an apparatus or appliance and for transmitting an operating status signal associated therewith to a receiver circuit, which is a spatially separated part of the signaling device and converts this signal into an optical, acoustic and/or tactile indicator signal and outputs the same.

From telecommunications and telecontrolling it is known to detect the operating status of motors, valves, pumps, relays and the like by means of a contact sense, an optical, magnetic and/or electrical sensor, and to transmit an operating status signal obtained in this manner by wireless or wire communication to a control station, where it is routed to a qualitative or quantitative display and/or, in dependence upon at least one evaluation criterion, generates from it by means of at least one threshold value circuit, an alarm signal whereby an optical or acoustic alarm is emitted.

Furthermore, it is known to continually measure the given current consumption of household appliances, such as a stove, washing machine, refrigerator, by means of an adapter that is connected in its connecting cable, and to wirelessly transmit the current measuring signal to an in-home center, where an energy consumption over a given time period and the present current consumption are determined from the received signal and brought to display.

These previously known devices are relatively complex on one hand, especially on their input end, and they are not immediately suitable to determine based on a reported transient status or current consumption, whether a washer or dryer or other intermittently operating appliance is in an end-of-operation status, which is of particular interest to the operator if the appliance is operated far away, especially several floors down in a basement.

In this context the situation frequently occurs that the operator of the appliance enters the room that is located outside the apartment, hoping/expecting that the washing or drying process has completed, and realizes that the given appliance has not completed the process and the program has not progressed to a point where it would be worth waiting. The appliance operator must then check again at a later time whether the process has now completed. The above described problems are even more obvious when the appliance operator, for example because of a given need to hurry, needs to have the washing and/or drying process complete in a speedy manner and other activities are to be performed in the meantime for reasons of expediency. If only one protected power connection exists for the washer and electric dryer, the necessity also exists in these cases to start the drying process immediately after completing the washing process. The attempt to derive the washing and drying times from experience fails in many cases since, especially depending on the type and amount of laundry, washing program, and temperature setting of the washer and dryer program, significantly different operating times result for the described appliances.

It is the object of the invention to evaluate from an operating status signal, specifically one stemming from an intermittently operating household appliance, whether an end-of-operation status has been reached and to emit the indicator signal accordingly.

This object is met in such a way that the operating status signal passes through an amplitude threshold value circuit and the portion of the signal exceeding the threshold value is routed to a re-triggerable time delay circuit, after the elapsed time of which the end-of-operation status signal is emitted for the generation of the alarm indicator signal.

Advantageous embodiments are specified in the subclaims.

The operating status signal for an electric washer or dryer can be obtained relatively easily in its connecting cable, e.g., by means of an outlet plug adapter or by means of a vibration or noise detector, without having to modify the appliance.

The current consumption of an appliance of this type will vary due to the different processes, such as heating, ventilating, pumping, and movement in alternating directions, as well as signal tone emission, signal light operation, and timer operation. In the process, transition times with relatively low current consumption occur between the phases with high consumption, and the end-of-operation status is characterized by a low current consumption of a comparatively longer duration. The amplitude threshold of the threshold circuit is accordingly set high enough so that the low consumptions of the signaling devices and timer clock are lower and the current flows of the larger power consumers, such as heating, ventilation, pump, spinning and agitating motor, exceed the threshold.

The threshold level can advantageously be preset by a program or circuit to provide for a simple adaptation to any desired appliance to be monitored. If the switching and evaluation circuit is programmable, the formation of the threshold value can be automated in such a way that, in a programming mode, the lowest current value measured in the end-of-operation status of the appliance being monitored is stored as a threshold value after adding a suitable increase, e.g., doubling, and made available as the threshold value for subsequent operations.

The delay time of the time delay circuit is set to be longer than the longest interval during the switching between the various operating phases. The delay time can also be suitably preset for the given appliance with a circuit or by means of a programming setting, or automatically stored and made available for future runs based on a run while in a programming mode, by measuring the longest interval and adding a suitable tolerance increase.

In lieu of a current measurement, which may take place for example by means of a transformatoric decoupling from a connecting cable into a measuring circuit, a measurement may also be taken of some other externally available measuring value and, e.g., a vibration or noise sensor may be disposed on the appliance which, when a motor is running or a buzzer is sounding, emits corresponding electrical signals. In this case the amplitude threshold must be set high enough so that common noises from the environment do not simulate an appliance operation. The delay time of a device of this type must be considerably longer than for a current consumption measurement, since heating times occur in many types of appliances during which a considerable amount of electricity is consumed but no motor is turned on, i.e., it is possible that no noise is generated. Pure heating times of this type must be bridged by selecting a longer delay time than for an evaluation by means of electric current measurements.

The two partial devices for evaluating the amplitude and later generating the delay time can be disposed on the sensor independently from one another, i.e., before the signal transmission path, or after same, before the indicator unit.

The transmission of the operating and/or end-of-operation signals takes place either by wire communication or wirelessly using a known transmission technique. Especially the mains network is suitable for transmitting coded modulated frequency signals or coded pulse series so that the receiver, using a suitable frequency filter, can selectively filter out the desired transmitter signal from a multitude of additional transmissions over the mains network, or certain code combinations serve to match the transmitter and receiver and given transmitter status.

To the extent that the measuring values are transmitted to the receiver for further evaluation, this may take place in analog form by means of amplitude modulation, frequency modulation, or pulse width modulation. However, these transmission modes continuously occupy a transmission channel, which is permitted only at low levels and corresponding short ranges.

More advantageous is a periodic transmission of a digitized measuring value or digitized status code word. The latter simplifies the transmit and receive circuits. Advantageously only two statuses are periodically transmitted, the operating status, which serves as a function control, and the end-of-operation status, which serves to signal the end of the operation.

The end-of-operation signaling may be presented to the user in various known manners, by generating an acoustic signal emission as a tone or melody or voice announcement, and/or a light signal, e.g., a preferably colored LED light-emitting diode, or excitement of a tactile vibrator. An additional optical display is advantageously provided as a function indicator for an operation of the appliance being monitored that has not yet completed. It will also indicate that the transmission path is operational.

If the receiver and display unit is to be connected to a plurality of signal sources, which accordingly have different station identifications by using different frequencies or transmitting different digital code words, a plurality of display means are accordingly disposed on the display unit, permitting a differentiation between the sources of the end-of-operation signal. Suitable display means are individual LED diodes or a numeric display, which, in each case, is actuated with a numeric character control associated with the given signal source and signal status. A tactile or acoustic signal of limited duration is additionally emitted as well.

Advantageous embodiments are shown in FIGS. 1-5.

FIG. 1 shows a diagram of a current consumption evaluation circuit with end-of-operation indicator unit,

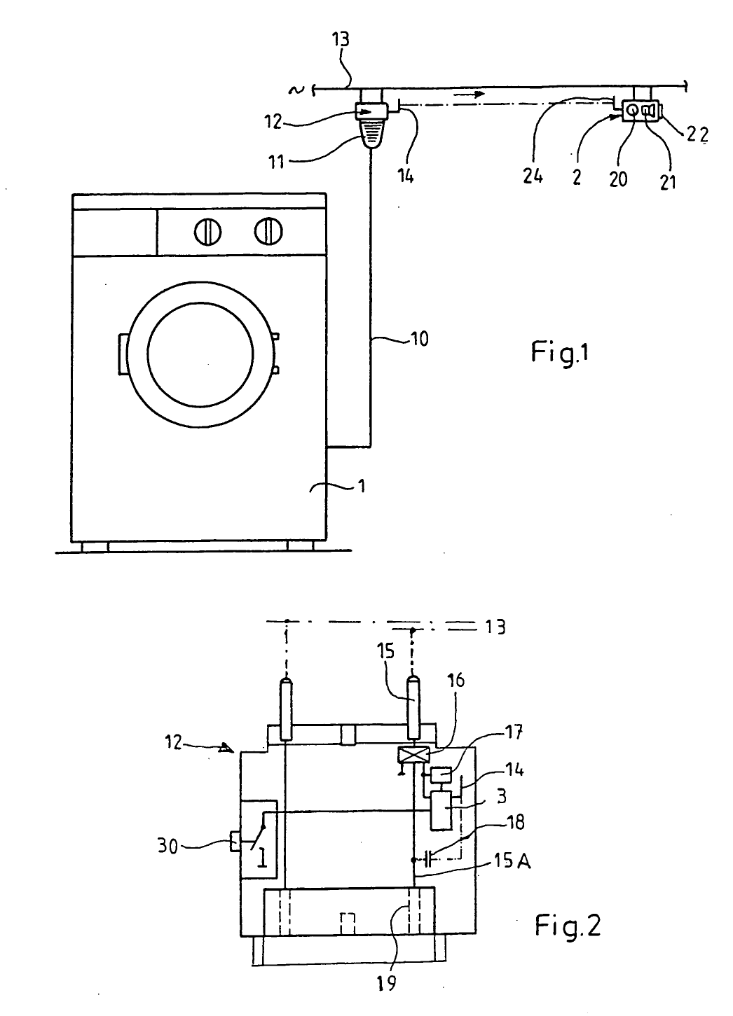

FIG. 2 shows a detail of the current evaluation circuit,

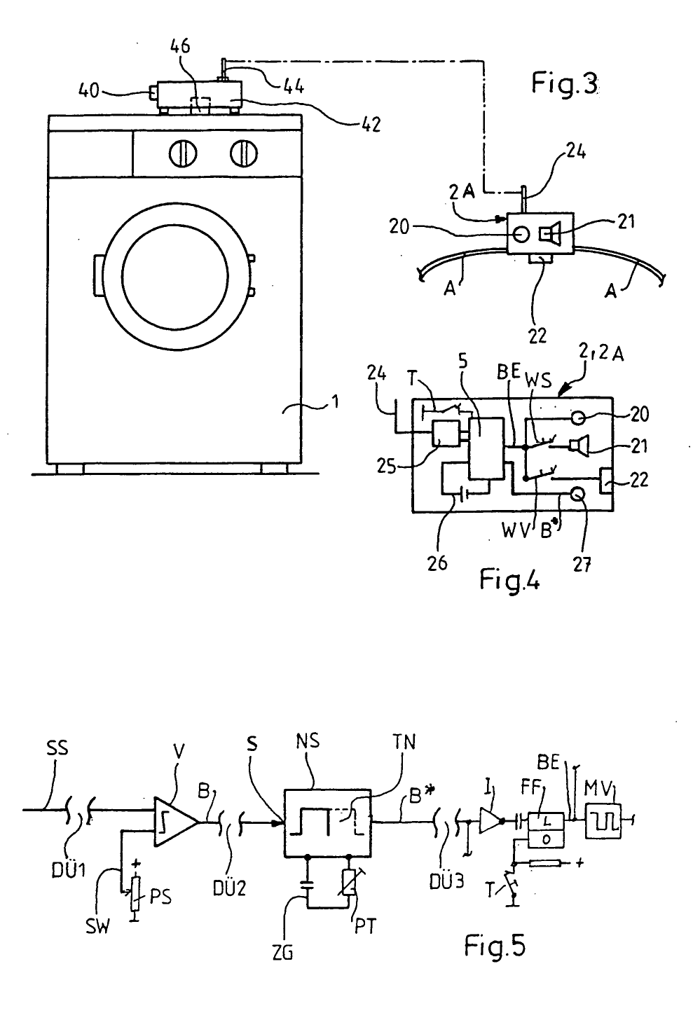

FIG. 3 shows a diagram of a vibration signal evaluation circuit with a signaling device,

FIG. 4 shows a circuit diagram of a receiver and signal transmitter device,

FIG. 5 shows a signal evaluation circuit diagram.

FIG. 1 is a schematic illustration of a washer or dryer 1, the power supply cable 10 of which is plugged with its plug 11 into a power supply adapter 12, which is connected to a mains network 13 by means of a wall socket.

Located in the adapter 12 is a current sensor circuit and a transmit circuit 14, which is connected wirelessly from antenna 14 to antenna 24, as indicated by a dot-and-dash line, or via the mains network 13 to a receiver 2 of a signaling device. The latter incorporates an optical, acoustic and/or tactile indicator 20-22, each of which signals an end of an operation.

FIG. 2 is a schematic illustration of a section through the adapter 12 with its plug prongs 15 on the mains network side and female connectors 19 on the appliance cable side, which are connected in each case so that the supply voltage can pass through them. Alternatively, the current measuring set-up may also be disposed in a recessed or surface-mounted housing, with the connectors located on a strip terminal.

One of the current-carrying lines, 15A, is routed through a transformer 16, which may consist, e.g., of a ferrite ring core and has a secondary winding, which produces a voltage-stable galvanic decoupling. The secondary voltage of the transformer 16 supplies a power supply unit 17, which supplies the switching circuit 3, which may be e.g., a microprocessor. Since the secondary voltage is proportional to the current flow in the primary line 15A, it is also supplied on the input side to the microprocessor 3 as a sensor voltage SS, where it is evaluated. The given operating status or the measured value itself are conditioned on the output side of the microcircuit 3 in a form suitable for data or signal processing and transmitted via an antenna 14 or mains network interaction impedance 18 to the current conductor 15A.

To automatically set an amplitude threshold value and a time threshold value, a program button 30 is provided, which signals to the microprocessor 3 on its input side that it should transition into a programming mode, during which it stores and evaluates the intensities of current and the associated durations during the following operation.

FIG. 3 shows an alternative operating status detection device 42, which is placed on or on top of an appliance 1 being monitored. With a sensor 46, which is preferably an electro-dynamic or piezo-electric transmitter, the detection device 42, which is preferably battery-operated, receives the appliance vibrations and/or noises stemming from the appliance motors, water flow, and/or buzzer, or the like.

These signals from the vibration receiver 46 are conditioned similar to the current sensor signals in FIG. 3 in a microprocessor or the like, and supplied to a data transmission or measuring value transmission means, e.g., via the antenna 44. A program button 40 serves for a programming function, as described above for the button 30.

The receiver unit 2A largely corresponds to the one described for FIG. 1, with a battery operation provided instead of a power connection. The receiver unit 2A is provided with a wristband A-A similar to a watch, and incorporates a vibrator signal transmitter 22, on the underside of the unit 2A that is worn towards the arm. The antenna 24, the optical LED display 20, and the signal tone emitter 21, as well as the housing are shown only schematically. They may be designed like in a wristwatch with an alarm function and receive function with internal antenna. Alternatively, a design along the type of a mobile telephone is provided with a belt clip.

Additional details of the embodiment of the receiver and signaling device 2, 2A are presented in FIG. 4. The operating status or measuring signal coming from the mains network or from the receive antenna 24 is conditioned in a receive circuit 25, such as filtered, demodulated, or the like, and then routed to the microprocessor 5 on its input side. The circuits 25, 5, are supplied by a battery 26, or optionally by a power supply unit.

As output signals, an operating status signal B is switched to an optical display 27 and an end-of operation signal BE is switched to an additional optical display 22, as well as via a first selector switch WS to a buzzer 21 and optionally via a second selector switch WV to a vibrator 22. A button T serves to confirm the alarm signaling and activate the ready mode. If during a predefined test period after actuation of the button T an operating signal occurs at the receive end, the circuit remains active until the end-of-operation status signaling has been detected and emitted.

FIG. 5 shows the significant structures of the circuit that serves to detect the end-of-operation status BE. The circuit consists of two functional areas, namely the amplitude evaluation and the pause time evaluation. These function groups can each be disposed either on the transmitter side or receiver side, i.e., the data transmission path can be either a measuring value transmission path DÜ1, or an operating status transmission path DÜ2, or an end-of-operation transmission path DÜ3. For reasons of an economical transmission path usage, the latter two variants are preferred since only a digital operating status signal B, B* must briefly be signaled periodically over the same as long as the operating status B, B* continues, i.e., as long as the end-of-operation status BE has not been reached. If no operating status signal B* exists, the end-of-operation status BE is formed by an inverter I, which is implemented in the circuit 5, FIG. 4.

To evaluate the measuring signal, the sensor signal SS is routed to a comparator V on its input side, which at its other input has a threshold value SW supplied to it, which is set higher than the measuring signal during phases of low activity of the appliance being monitored, and especially during its end-of-operation status.

The comparator V is preferably provided with a hysteresis and emits pulse-type signals as long as the measuring signal signals a high degree of activity, i.e., high current consumption or high vibration level. This operating signal B consisting of electrical pulses is supplied to a delay circuit NS at the setting input S. It is a so-called retriggerable monostable multivibrator that is provided with a timing circuit ZG, which determines a delay time TN during which the on-status is maintained at the output between the input pulses, i.e., an operating status signal B* is continually emitted there without pause if the intervals of the input pulses are shorter than the delay time TN. Only when, at the end of the operation, no activity is being signaled beyond the delay time TN, the output signal B* drops and the following inverter I signals the end-of-operation status BE, which is converted to the indicator signals.

The delay time TN is suitably set, for example, on a potentiometer PT so that the pauses during the active operation, which occur during switch-overs, etc., are bridged.

The amplitude threshold value SW is also set on a potentiometer PS, with the current measuring signal or vibration signal at the end of the operation being taken into account in such a way that the threshold is a littler higher.

With laundry dryers, which generally continue to run for a very long time with a so-called anti-creasing program, during which the drum is briefly rotated in relatively long intervals, an early end-of-operation signaling may be brought about with a suitable selection of the delay time that is shorter than the above intervals of the drum rotations in the anti-creasing program, after which the anti-creasing program continues to run, but the thus notified operator can pick up the dry laundry at any time.

Besides selecting a suitable delay time, an additional embodiment takes advantage of the fact, in order to detect the end of the operation, that the drum is rotated only briefly during the anti-creasing program in relatively long intervals. For evaluation purposes, the relation of the given pause time to the corresponding overall operating time is formed, including drum rotation times, and subjected to a threshold value evaluation.

The functions shown for FIG. 5 can be implemented alternatively in a known manner as program functions of the microprocessor 3, FIG. 2. The microprocessor 3 or 5 additionally generates the timing pulses for the acoustic or tactile indicator signal.

The operating status signal that has been stabilized in the time delay circuit NS is optionally made available after the transmission path for an operation indication and routed via the inverter I and a differentiator to the setting input of a bistable flip-flop FF, which thus signals the end of the operation BE at its output. The end-of-operation status signal BE is routed to a multivibrator MV, which generates an acoustic signal to the acoustic emitter or, with a lower frequency, actuates a vibrator.

The button T, when actuated, generates a reset signal for the flip-flop FF, which, in zero condition, turns off the end-of-operation signal BE.

1. A signaling device (12, 2; 42, 2A) for detecting an operating status (B) of an appliance (1), such as a washing machine or laundry dryer, and for transmitting an operating status signal (SS, B, B*) associated therewith from a transmitter device (14) to a receiver circuit (2, 42), which is a spatially separated part of the signaling device (12, 2; 42, 2A), and for converting this operating status signal (SS, B, B*) into an optical, acoustic and/or tactile indicator signal, as well as emitting same, whereby in a microprocessor (3) a given operating status measuring signal (SS) passes through an amplitude threshold value circuit (V), from same only the signal portion (B) that exceeds a predefinable threshold value (SW) in each case is routed to a re-triggerable time delay circuit (NS) with a predefinable time delay (NT), after the elapsed time of which an end-of-operation signal (BE) is emitted for conversion into the indicator signal,
characterized in that, in a setting program actuated in the microprocessor (3) by a button (30), the operating status measuring signal (SS) measured during one complete operation of a washing or drying program with or without anti-creasing program segment, is automatically detected with respect to the given occurred amplitudes and associated durations, as well as intermittent times of pauses or low signals, and the level of the threshold value (SW) is derived therefrom somewhat above the operating status measuring signal (SS) measured at the end of the operation, and the time delay (NT) is derived therefrom somewhat longer than the longest detected pause time or low-signal time and this threshold value (SW), as well as this time delay (NT) is stored and used as a default for subsequent program runs.

2. A signaling device according to claim 1, characterized in that the appropriate operating status signal (SS) is formed by detecting a given operating current or a given vibration of the appliance (1).

3. A signaling device according to claim 2, characterized in that the microprocessor (3) is disposed together with a power supply unit (17) and the transmitter device (14) in a power plug adapter (12), electrical outlet, or power supply terminal block.

4. A signaling device according to claims claim 1, characterized in that the receiver (2, 2A) routes the end-of-operation status signal (BE) to a hold circuit (FF), which feeds an optical display (20) and, via a multivibrator (MV), an acoustic or tactile transmitter (21, 22).

5. A signaling device according to claim 4, characterized in that the hold circuit (FF) is re-settable by means of a button signal (T).

6. A signaling device according to claim 4, characterized in that the acoustic transmitter (21) and the tactile transmitter (22) each are activated with the multivibrator signal by a selector switch (WS, WV).

7. A signaling device according to claim 6, characterized in that the tactile transmitter (22) is disposed facing the body or arm of a person wearing the receiver (2).

8. A signaling device according to claim 1, characterized in that, in addition to the end-of-operation status signal (BE), the continuous operating status signal (B*) of the time delay circuit (NS) is also transmitted to the receiver circuit (2) and emitted by same to an optical display (27).

9. A signaling device according to claim 1, characterized in that a comparison time, to which a low-voltage anti-creasing pause time is compared is determined in each case in the setting program in dependence upon a total operation time, and when this comparison time is exceeded the end-of-operation status signal (BE) is generated.
